(19) United States
(12) Patent Application Publication
(10) Pub. No.: US 2009/0125634 A1
(43) Pub. Date: May 14, 2009

(54) NETWORK MEDIA STREAMING WITH PARTIAL SYNCING

(75) Inventors: Gurpratap Virdi, Bellevue, WA (US); Todd Bowra, Redmond, WA (US); Nicholas Fang, Redmond, WA (US); Amit Pande, Kirkland, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/936,792

(22) Filed: Nov. 8, 2007

(51) Int. Cl. G06F 15/16

(52) U.S. Cl. 709/231

(57) ABSTRACT

Partial content syncing in a network media receiver is disclosed. One embodiment comprises identifying available cache space on the media receiver, detecting a media data file to be downloaded from a media server, and pre-buffering a portion of the media data on the media receiver prior to selection of the media data file for playback. In this manner, substantially glitch-free playback of a media data file may be started with little delay and with relatively little local storage.

### BACKGROUND

As computing and communication networks continue to evolve, media is increasingly being stored, shared, and played over these networks. However, network-based media players can be adversely impacted by network constraints. For example, a wireless network may not have sufficient bandwidth for glitch-free playback of streamed media.

One approach to enabling glitch-free playback involves pre-buffering a small amount of content after a user selects a media data file for playback but before starting playback. However, this may introduce startup latency associated with buffering before playback begins. Another approach to generate glitch-free playback and also to reduce startup latency is to synchronize (sync) a network media receiver with a media server in order to store a media data file locally on the media receiver before playback begins. Because the full file is stored locally, network limitations do not affect the playback process. However, for large media data files or a large amount of overall content, the sync process may be time-consuming and inconvenient, and therefore may limit a user's playback selections to those items that were previously selected to be synced. Further, this approach may not work as well on media receivers without large amounts of memory or local storage.

### SUMMARY

Accordingly, various embodiments for network media streaming with partial content syncing are described below in the Detailed Description. For example, one disclosed embodiment comprises identifying available cache space on the media receiver, detecting a media data file to be downloaded from a media server, and pre-buffering a portion of the media data on the media receiver prior to selection of the media data file for playback. In this manner, substantially glitch-free playback of a media data file may be started with little delay.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an example of an embodiment of a home media environment.

FIG. 2 shows a block diagram of embodiments of a media server and a media receiver of the home media environment of FIG. 1.

FIG. 3 shows a flow diagram of an embodiment of a method for network media streaming with partial content syncing.

FIG. 4 shows a flow diagram of an embodiment of a method for network media streaming with partial content syncing according to media playback and network performance characteristics.

### DETAILED DESCRIPTION

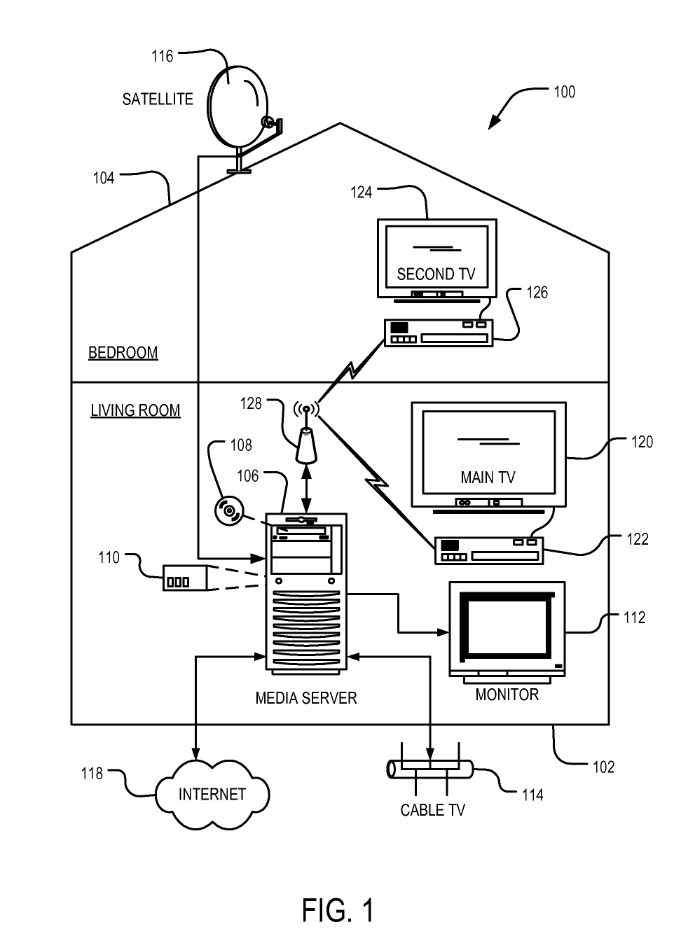

Prior to discussing embodiments for partial syncing of media data prior to selection of the content for playback, an example streaming media use environment is described. FIG. 1 depicts an exemplary home entertainment environment 100 including a living room 102 and a bedroom 104. Central to the home entertainment environment 100 is a media server 106, in this implementation situated in the living room 102, but which could be located anywhere within the house or in communication with devices in the house through a network 128. In one implementation, the media server 106 is a conventional personal computer (PC) configured to run a multimedia software package, for example, the Windows Vista Ultimate operating system with Windows Media Center (available from Microsoft Corporation of Redmond, Wash.). In such a configuration, the media server 106 is able to integrate full computing functionality with a complete home entertainment system into a single PC. For example, a user can watch television (TV) in one graphical window of an attached video monitor 112, while sending e-mail or working on a spreadsheet in another graphical window on the same monitor 112. In addition, the media server 106 may also include other features or components, for example: a digital video recorder (DVR) to capture video content for future viewing or to record the future broadcast of a single program or series; a compact disc (CD) or digital video disc (DVD) drive 108 for disc media playback; a memory drive 110 for integrated storage of and access to a user's recorded content, such as TV shows, songs, pictures, data, media, and home videos; and an electronic program guide (EPG) (not shown in FIG. 1).

Instead of a conventional PC, the media server 106 may comprise a variety of other devices capable of storing and distributing media data including, for example, a notebook or portable computer, a tablet PC, a workstation, a server, an Internet appliance, a DVR, or combinations thereof. The media server 106 may also be a set-top box capable of delivering media data to a computer where it may be streamed, or the set-top box itself could stream the media data. As the media server 106 may be a full function computer running an operating system, the user may also have the option to run standard computer programs (e.g., word processing and spreadsheets), send and receive e-mails, browse the Internet, or perform other functions.

In addition to storing media data, the media server 106 may be connected with a variety of media sources, for example, a cable connection 114, a satellite receiver 116, an antenna (not shown), and/or a network such as the Internet 118. A user may thus control a live stream of media data (e.g., TV content) received, for example, via the cable connection 114, the satellite receiver 116, or antenna. This capability may be enabled by one or more tuners residing in the media server 106. The one or more tuners may alternatively be located remote from the media server 106. In either case, the user may choose a tuner to fit any particular preferences. For example, a user wishing to watch both standard definition (SD) and high definition (HD) content may employ a tuner configured for both types of content. Alternately, the user may employ an SD tuner for SD content and an HD tuner for HD content separately.

The TV content may be received as an analog (i.e., radio frequency) signal or a digital signal (e.g., digital cable). The received TV content may include discrete content packets, where each content packet includes actual TV content (i.e., audio and video data). If TV content is received as an analog signal, discrete content packets may be created from the analog signal.

The entertainment environment 100 may also include one or more network devices functioning as media receivers 122, 126 placed in communication with the media server 106 through a network 128, for example, a local area network (LAN). In an exemplary embodiment, each media receiver 122, 126 may be a Media Center Extender device, for example, an Xbox 360™ (Microsoft Corporation, Redmond, Wash.). The media receivers 122, 126 may also be implemented as any of a variety of conventional media rendering or computing devices, including, for example, a set-top box, a television, a video gaming console, a desktop PC, a notebook or portable computer, a workstation, an Internet appliance, a handheld PC, a cellular telephone or other wireless communications device, a personal digital assistant (PDA), a network capable device, or combinations thereof. Furthermore, the media receivers 122, 126 may include a tuner as described above.

The network 128 may comprise a wired and/or wireless network, for example, cable, Ethernet, WiFi, a wireless access point (WAP), or any other electronic, radio frequency or optical coupling means, including the Internet. The network 128 may enable communication between the media server 106, the media receivers 122 and 126, and any other connected device through packet-based communication protocols, such as Transmission Control Protocol (TCP), Internet Protocol (IP), Real-time Transport Protocol (RTP), User Datagram Protocol (UDP) and Real-time Transport Control Protocol (RTCP), or other packet based communication protocols, as examples. Communications may be transmitted directly between devices over a LAN, or they may be carried over a wide area network (WAN), for example, the Internet 118.

Entertainment environment 100 may include one or more video display devices, for example a main TV 120 in the living room 102, a secondary TV 124 in the bedroom 104, and a video monitor 112 in the entertainment environment 100. These video display devices may be connected with the media server 106 via the network 128 either directly or via the media receivers 122, 126. As shown in the example of FIG. 1, the main TV 120 and the secondary TV 124 may be coupled to the media receivers 122, 126 through conventional cables. The video monitor 112 may be coupled with the media server 106 directly via a video cable. The media server 106 and media receivers 122, 126 may alternatively be coupled with any of a variety of video and audio presentation devices and by other couplings than conventional cables. Media data including TV content may thus be supplied to each of the video display devices 112, 120, 124 over the home network 128 from the media server 106 situated in the living room 104.

The media receivers 122, 126 may be configured to receive streamed media data, including video and TV content, from the media server 106. Media data, and particularly video and TV content, may be transmitted from the media server 106 to the media receivers 122, 126 as streaming media comprised of discrete content packets via the network protocols described above, or even other network protocols. The streamed media data may comprise IPTV (television content delivered over the Internet), SD, and HD content, including video, audio, and image files, decoded on the media receivers 122, 126 for presentation on the connected TVs 120 and 124. The media data may further be “mixed” with additional content, for example, an EPG, presentation content related to the media data, a web browser window, and other user interface environments transmitted from the media server for output on the TVs 120, 124 or the monitor 112. Such additional media data may be delivered in a variety of ways using different protocols, including, for example, standard Remote Desktop Protocol (RDP), Graphics Device Interface (GDI), Hypertext Markup Language (HTML), or other protocols providing similar functionality.

In addition to the media receivers 122, 126 and the video display devices 112, 120, 124, the media server 106 may be connected with other peripheral devices, including components such as a DVR, cable or satellite set-top boxes, speakers, a printer (not shown), etc. The media server 106 and/or media receivers 122, 126 may also enable multi-channel output for speakers. This may be accomplished through the use of digital interconnect outputs, such as Sony-Philips Digital Interface Format (S/PDIF) or TOSLINK® enabling the delivery of Dolby Digital, Digital Theater Sound (DTS), or Pulse Code Modulation (PCM).

Prior to discussing embodiments of partial content syncing in detail, it will be appreciated that the embodiments described herein may be implemented, for example, via computer-executable instructions or code, such as programs, stored on a computer-readable storage medium and executed by a computing device. Generally, programs include routines, objects, components, data structures, and the like that perform particular tasks or implement particular abstract data types. As used herein, the term “program” may connote a single program or multiple programs acting in concert, and may be used to denote applications, services, or any other type or class of program. Likewise, the terms “computer” and “computing device” as used herein include any device that electronically executes one or more programs, including but not limited to media server 106, media receivers 122, 126, and any other suitable device such as personal computers, servers, laptop computers, hand-held devices, cellular phones, microprocessor-based programmable consumer electronics and/or appliances, routers, gateways, hubs and other computer networking devices.

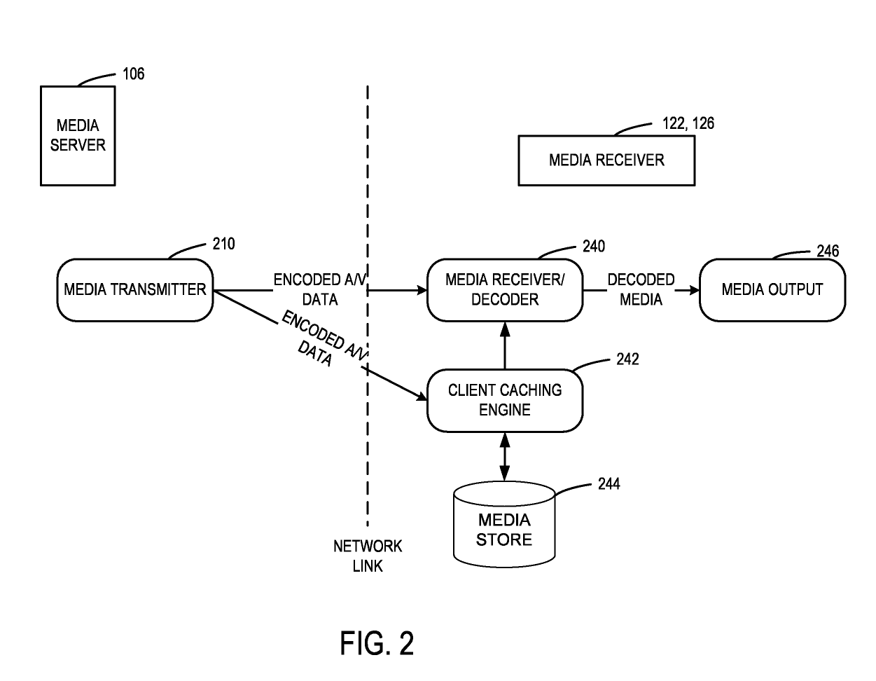

FIG. 2 shows a block diagram of a media server 106 and a media receiver 122 or 126 of the embodiment of FIG. 1. While the description below of the media receiver is made primarily with reference to media receiver 122, it will be understood that the descriptions also extend to media receiver 126, as well as other suitable media receivers. Further, while media receiver 122 may be described herein as a playback device, it will be understood that a media receiver may instead be coupled with a separate media playback device.

Media server 106 includes a media transmitter 210 configured to transmit media data over a network link to media receiver 122 for playback or caching. As depicted in the embodiment in FIG. 2, media receiver 122 includes a media receiver/decoder 240 configured to receive encoded A/V data from media transmitter 210, and a client caching engine 242 coupled with media receiver/decoder 240. Media receiver 122 further includes a media store 244 in communication with client caching engine 242. Media receiver/decoder 240 is further in communication with media output module 246 such that media receiver/decoder 240 may provide decoded media to media output module 246. Media output module 246 may be configured to play audio data, audio/video data, or any other suitable type of media data.

As mentioned above, client caching engine 242 and/or media store 244 may be configured to pre-buffer or cache a portion of the media data stored on media server 106 prior to selection for playback via media output module 246. The term “portion” as used herein signifies that some, but not all, of a media data file is synced prior to selection of the file for playback. This is in contrast to other methods of caching and playback, which generally involve a selection of a media data file for playback before any caching is performed. In comparison with the conventional streaming model in which some initial portion of a media data file is buffered after selection for playback but before playback begins, pre-buffering a portion of the media data file prior to selection for playback allows playback to begin immediately upon selection, without noticeable lag. Likewise, in comparison with the conventional syncing model in which an entire media data file is saved to the media receiver prior to playback, the partial syncing model allows for the local storage of a greater number of different playback options that can be viewed without initial lag and with the use of less local memory than for a full sync process.

The partial syncing of media data prior to selection for playback may enable various use scenarios. For example, in the case of IP television, a short initial segment of each of a plurality of television shows that are available for viewing (for example, in a selected time frame, such as the next hour, day, etc.) may be automatically downloaded prior to a user selecting any of the shows for playback. Then, upon selection of any of the partially synced shows, playback of the show may begin immediately, without lag. Further, the unbuffered portion of the show may be streamed to the media receiver during viewing, thereby enabling the entire show to be viewed without glitching. Likewise, an initial portion of each of a set of movie trailers for new movie releases may be automatically downloaded and saved on media receiver 122 so that a user may later view a desired trailer without initial lag. In either of these examples, because only a portion of each media data file is synced and stored locally, unwanted items do not occupy much space and therefore do not interfere with the use of media receiver 122 to receive and play desired items. It will be appreciated that this use scenario is described for the purpose of example, and is not intended to be limiting in any sense.

Continuing with FIG. 2, upon selection of a media data file by a user for playback, media receiver/decoder 240 is configured first to receive and decode the portion of media data cached in the media store 244, and to provide this portion of the media data to the media output module 246. Further, during playback, media transmitter 210 streams the portion of the media data that is not cached to the media media stream is cached during streaming. In other words, a playback cache used during playback may be associated with either the media receiver/decoder 240 or the client caching engine 242. In this manner the media data file can be played almost immediately, without noticeable lag. Additionally, by pre-caching a sufficient portion of a media data file in view of the limitations of the network link, the size of the media store 244, and other system limitations, playback may also be substantially glitch free, as long as playback does not catch up with the receipt of the streaming media data.

Any suitable portion of a media data file may be cached prior to playback. For example, as described above, a first portion of the media data file (for example, a first x seconds of the media data file) may be pre-buffered where it is desired to begin playback without noticeable lag. Likewise, where it is desired to enable instantaneous trick mode playback, such as fast-forward playback or seeks through content, a series of key frames, such as I-frames in MPEG-2, may be cached. By pre-caching key frames, a user may enable trick modes such as fast forward, chapter selection, etc., of a media data file without the delays usually associated with trick mode playback. In some embodiments, a full set of key frames may be pre-buffered (i.e. all key frames in a media data file), while in other embodiments, a portion of a total number of key frames (for example, every nth key frame) may be pre-buffered.

Client caching engine 242 may be configured to determine how much of a media data file to pre-buffer in any suitable manner. For example, in some embodiments, media receiver 122 may be configured to pre-buffer a predetermined, fixed portion of a data file or a plurality of media data files. In other embodiments, the client caching engine 242 may be configured to identify an amount of buffer space available in the media store 244, or otherwise available for pre-buffering, and then to download a portion of each media data file based upon an amount of the media data file that can fit within the available buffer space.

Further, the client caching engine 242 may be configured to determine how much of a media data file to pre-buffer based upon other factors than available buffer space. For example, in some embodiments, media receiver 122 may be configured to monitor the bandwidth of the network link between media server 106 and media receiver 122, and to download a sufficient portion of a media data file to ensure glitch-free playback at average network bandwidths. The determined network bandwidth may be used to adjust other operating parameters as well. For example, in some embodiments, the pre-buffering of media data may occur when the available network bandwidth is above a certain threshold. In this way, a near-capacity network may be taken into consideration and portions of the media data may be downloaded at times of greater available bandwidth. Similarly, in some embodiments, media receiver 122 may be configured to download a portion of media data and cache the portion in media store 244 while a second media data file is being played by media receiver 122.

In some embodiments, media receiver 122 may determine how much of a media data file or what portion of media data to pre-buffer based upon a desired playback performance characteristic. For example, media receiver 122 may be specifically configured to pre-cache a portion of media data to improve quick stream startup, or a different portion of media data to provide substantially glitch-free playback, etc. By building a device-side partial cache of media data files also stored on media server 106, media receiver 122 is able to deliver a more robust playback experience with minimal local storage. For example, in the case of a 1 Mbps WMV file, near instantaneous startup of playback can be enabled by caching 250 KB of data, approximately equal to 2 seconds of playback. Likewise, in the case of 18 Mbps HDTV playback on a network that is near capacity for the bandwidth required for playback of HD content, it may be possible to enable glitch-free playback of a 60 minute TV show by caching 22.5 MB of data, which is approximately equal to 10 seconds of playback.

The above-described embodiments may also allow media receiver 122 to play content that is a higher bit rate than that supported by a network connection. For example, a high-definition television show may be at 10 Mbps yet streamed over a connection that supports 5 Mbps throughput. In this example, an embodiment may sync half the television show in advance to enable the substantially glitch-free playback of the entire show.

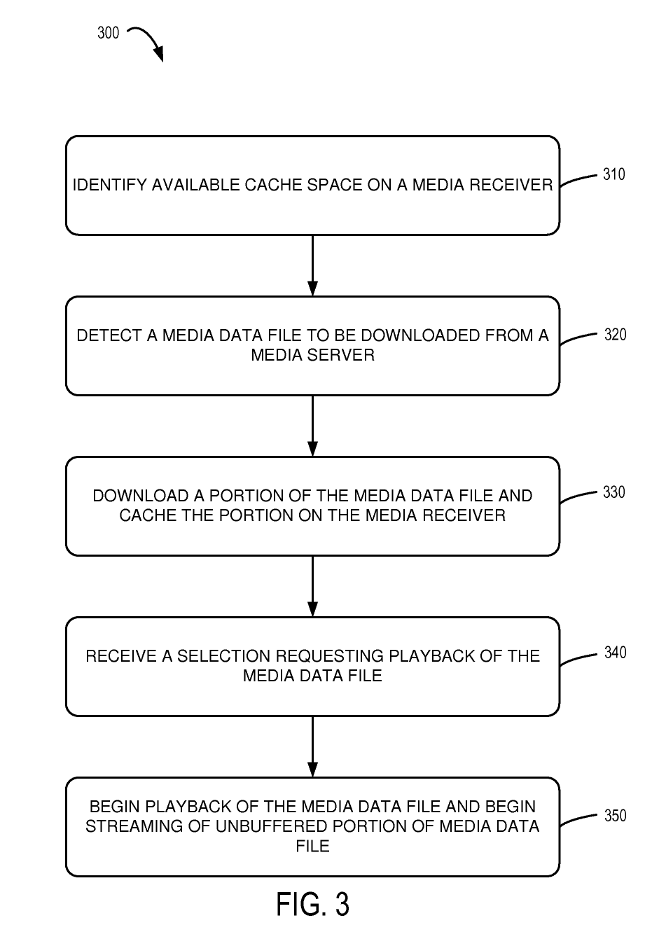

FIG. 3 shows a flow diagram of an embodiment of a method 300 for network media streaming with partial content syncing. In block 310, the method identifies available cache space on a media receiver 122. Then, the method detects a media data file to be downloaded from a media server 106 in block 320, and downloads a portion of the media data and caches the portion on the media receiver 122 in block 330, wherein the caching occurs prior to a user selection of the media data for playback. Next, as shown in block 340, method 300 comprises receiving a selection of (i.e. a choice of) the media data file for playback. Finally, at 350, playback of the previously buffered portion of the media data file and streaming of the unbuffered portion of the media data file begins after the selection for playback is received.

Some embodiments may also comprise methods to perform actions of the system described above with reference to FIG. 2, or within the principles otherwise in this disclosure. For example, in some embodiments a method may also identify a plurality of media data files stored on the media server 106, determine an amount of each media data file to be cached on a media receiver 122, and download a portion of each media data file and cache the portion of each media data file on the media receiver 122. Further, some embodiments may identify an amount of cache space available on a media receiver 122 and download a portion of each media data file determined to fit within the amount of cache space available on the media receiver 122. Additionally, some embodiments may further perform a method that comprises monitoring network connection bandwidth, and downloading a portion of media data when the available network bandwidth is above a certain threshold. Similarly, some methods may further comprise downloading a portion of the media data and caching the portion on the media receiver 122 while a second media data file is being played by the media receiver 122.

The portion of media data that is loaded may be a beginning portion of a media data file, or other portions of the media data file. In this manner, the portion of media data that is pre-cached may be a series of key frames. By pre-caching key frames, a user may enable trick modes such as fast forward, chapter selection, etc., of a media data file without the delays usually associated with buffering a media data file after selection by a user.

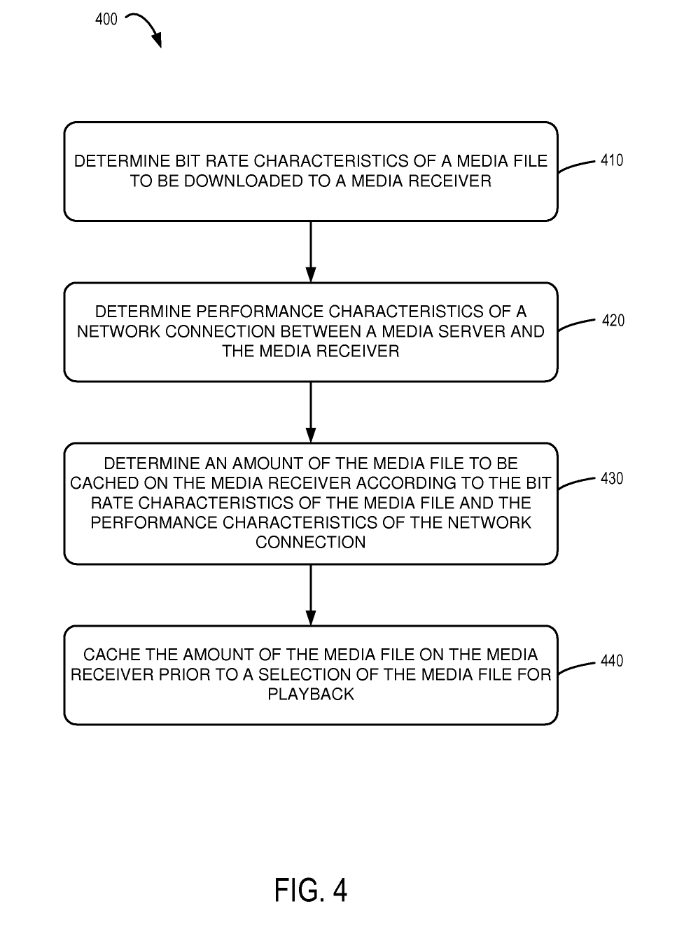

An example of an embodiment that performs partial content syncing according to media playback and network performance characteristics is shown generally at 400 in FIG. 4. First, in block 410, method 400 determines the bit rate of a media data file to be downloaded to a media receiver 122. Then, in block 420, the method determines one or more performance characteristics of a network connection between a media server 106 and the media receiver 122, such as an average or immediate network bandwidth available. Next, in block 430, an amount of the media data file to be cached on the media receiver is determined according to the bit rate characteristics of the media data file and the performance characteristics of the network connection in block 430. Then method 400 caches the amount of the media data file on the media receiver 122 prior to playback of the media data file. Method 400 may further include the variations depicted with reference to method 300 as described in reference to FIG. 3, or may also perform the functionality of the system in FIG. 2 or according to other principles covered within this disclosure or by their equivalents.

While described herein in the context of a home streaming media environment, it will be appreciated that the concepts disclosed herein may be used in any suitable streaming media environment, including but not limited to other client-server-based use environments and peer-to-peer-based use environments. Furthermore, while the media server and media receiver are shown herein as being located on different devices, it will be understood that these components may comprise separate components, modules, programs or other entities running on a single device.

It will further be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of any of the above-described processes is not necessarily required to achieve the features and/or results of the embodiments described herein, but is provided for ease of illustration and description. The subject matter of the present disclosure includes all novel and nonobvious combinations and subcombinations of the various processes, systems and configurations, and other features, functions, acts, and/or properties disclosed herein, as well as any and all equivalents thereof.

1. A method of playing a media data file on a media receiver, the method comprising:
identifying available cache space on the media receiver;
detecting a media data file to be downloaded from a media server; and
downloading a portion of the media data file and caching the portion of the media data file on the media receiver prior to selection of the media data file for playback.

2. The method of claim 1, further comprising:
identifying a plurality of media data files stored on the media server;
determining a portion of each media data file to be cached on the media receiver; and
downloading the portion of each media data file and caching the portion of each media data file on the media receiver.

3. The method of claim 1, further comprising identifying an amount of cache space available on the media receiver and downloading the portion of the media data file based upon the amount of cache space available on the media receiver.

4. The method of claim 1, wherein the portion of the media data file comprises a series of key frames.

5. The method of claim 1, wherein the portion of the media data file comprises a beginning portion of the media data.

6. The method of claim 1, further comprising monitoring network connection bandwidth, and downloading the portion of the media data when the available network bandwidth is above a certain threshold.

7. The method of claim 1, further comprising downloading a portion of the media data and caching the portion on the media receiver while another media data file is being played by the media receiver.

8. A computer-readable medium comprising computer-executable instructions for partially syncing media on a media receiver, the instructions being executable by the media receiver to perform a method comprising:
detecting a media data file on a remote media server;
receiving a portion of the media data file from the media server, and caching the portion of the media data file on the media receiver prior to selection of the media data file for playback; and
after receiving selection of the media data file for playback, receiving a stream of an unbuffered portion of the media data file from the media server while playing the portion of the media data file.

9. The computer-readable medium of claim 8, further comprising instructions executable by the media receiver to identify an amount of cache space available on the media receiver and to download a portion of each of a plurality of media data files based upon the amount of cache space available on the media receiver.

10. The computer-readable medium of claim 8, wherein the portion of the media data file comprises a series of key frames.

11. The computer-readable medium of claim 8, wherein the portion of the media data file further comprises a beginning portion of the media data file.

12. The computer-readable medium of claim 8, further comprising instructions executable by the media receiver to monitor network connection bandwidth, and to download the portion of the media data file only when the available network bandwidth is above a certain threshold.

13. The computer-readable medium of claim 8, further comprising instructions executable by the media receiver to download a portion of the media data file and to cache the portion of the media data file on the media receiver while a second media data file is being played by the media receiver.

14. In a networked media receiver, a method of playing a media data file, the method comprising:
determining a bit rate of the media data file before downloading the media data to the media receiver;
determining a performance characteristic of a network connection between a media server and the media receiver;
determining a portion of the media data file to be cached on the media receiver based upon the bit rate of the media data file and the performance characteristic of the network connection; and
caching the portion of the media data file on the media receiver prior to selection of the media data file for playback.

15. The method of claim 14, wherein determining a network performance characteristic comprises determining an average bandwidth of the network and/or an instantaneous bandwidth of the network.

16. The method of claim 14, wherein the portion of media data comprises a series of key frames and/or a beginning portion of the media data file.

17. The method of claim 14, further comprising identifying an amount of cache space available on the media receiver, and determining the portion of the media data file to be cached on the media receiver based upon the amount of cache space available on the media receiver.

18. The method of claim 14, further comprising downloading the portion of the media data when the available network bandwidth is above a certain threshold.

19. The method of claim 14, further comprising:
identifying a plurality of media data files stored on the media server;
determining an amount of each media data file to be cached on the media receiver; and
downloading a portion of each media data file and caching the portion of each media data file on the media receiver.

20. The method of claim 14, further comprising downloading a portion of the media data and caching the portion on the media receiver while a second media data file is being played by the media receiver.
